(19) United States
(12) Patent Application Publication
(10) Pub. No.: US 2002/0188511 A1
(43) Pub. Date: Dec. 12, 2002

(54) Interactive online point redemption system

(75) Inventors: Christopher Johnson, Glen Allen, VA (US); Marti Beller, Richmond, VA (US)

Correspondence Address: ROTHWELL, FIGG, ERNST & MANBECK, P.C., 1425 K STREET, N.W., SUITE 800, WASHINGTON, DC, 20005, US

(73) Assignee: Trilegiant Loyalty Solutions, Richmond, VA

(21) Appl. No.: 10/143,866

(22) Filed: May 14, 2002

Related U.S. Application Data
(60) Provisional application No. 60/290,359, filed on May 14, 2001.

(51) Int. Cl. G06F 17/60

(52) U.S. Cl. 705/14

(57) ABSTRACT

A system and method for implementing customer loyalty reward programs instituted by different third party merchants, includes a loyalty database storing customer loyalty reward program data defining a customer loyalty reward program for each of a plurality of different third party merchants, and storing customer loyalty account information for customers enrolled in each of the third party merchants' customer loyalty reward programs. A server interacts with customers and the loyalty database to execute redemption of rewards as selected by a customer based on the customer's loyalty account information and associated customer loyalty reward program data.

### CROSS-REFERENCE TO RELATED APPLICATION

This application claims the benefit of the filing date of provisional application Serial No. 60/290,359, filed on May 14, 2001, under 35 U.S.C. §119(e).

### FIELD OF THE INVENTION

The present invention relates generally to customer loyalty programs and, in particular, to an interactive online point redemption system and method for redeeming accumulated loyalty points over a distributed computer network such as the Internet.

### SUMMARY OF THE INVENTION

A first aspect of the present invention is characterized in a method of redeeming customer loyalty points online using an interactive point redemption system. In general, the method includes receiving customer data from clients (e.g., merchants selling goods and/or services) that operate customer loyalty programs, loading the data into a loyalty database, adjusting point balances, and providing customers access to the data and redemption processes via a website. The system can also enforce program rules such as monthly point caps, etc.

Customers participating in a loyalty program can activate their accounts on the system by visiting the redemption website directly and logging on, or by logging on to the client's (i.e. merchant's) website and transferring to the redemption website through the merchant's website. Once a customer account is activated, the customer can review point balances and redemption activity via the website. The customer can also redeem points for awards such as airline tickets, gift certificates, and merchandise. Optional access to program information and customer service may also be provided.

In order to redeem an airline ticket, the customer utilizes a booking engine, such as Cendant FareAgent™, from within the interactive point redemption system. Tickets can be booked online and reservations are made using an airline reservation system, such as the SABRE system. Prior to processing by the booking system, the interactive point redemption system verifies that all customer requests meet the program requirements established by the client (e.g., number of days in advance, zones, Saturday night stay requirement, etc.). The interactive point redemption system then processes tickets and mails them out to customers once manual verification of point balances is complete.

A second aspect of the present invention is generally characterized in an interactive point redemption system implementing the above method.

### BRIEF DESCRIPTION OF THE DRAWINGS

FIG. 1 is a schematic diagram showing an implementation of an interactive online point redemption system according to the present invention;

FIG. 2 is a site map showing the architecture of a website hosted by an interactive online point redemption system according to the present invention;

FIG. 3 is a flow chart showing an embodiment of an interactive online point redemption method according to the present invention; and

FIG. 4 is a flow chart showing an embodiment of an airline travel redemption method for use with the interactive online point redemption method of the present invention.

### DETAILED DESCRIPTION OF THE PREFERRED EMBODIMENT

An exemplary embodiment of an interactive point redemption system according to the present invention is described herein as being implemented over a distributed network such as the Internet. It will be appreciated, however, that the inventive system can be implemented over any communication medium including, but not limited to, local area networks, wide area networks, and dedicated dial-up connections. Furthermore, while the inventive system is described with specific reference to a method of redeeming loyalty points for airline travel, it will be appreciated that other types of awards can be offered for redemption by the system. Some examples of the types of awards that can be offered in addition to or in lieu of airline travel include, but are not limited to, coupons, gift certificates, and merchandise.

The interactive point redemption system according to the present invention is intended primarily as an independent system for use in conjunction with one or more third party loyalty programs wherein points or credits are awarded to enrolled customers or members under certain circumstances in an effort to induce customer loyalty relative to the third party's products or services. It will be appreciated, however, that the interactive point redemption system can be operated by a party as an integral part of their customer loyalty program if desired. In the following description of the interactive point redemption system, it is assumed for purposes of simplicity that a customer has already enrolled in a third party customer loyalty program and been assigned a user name or identifier. The system allows the client to assign a unique user name or identifier to each customer. For example, the client may wish to use credit card number, social security number, a unique member number, etc., to identify customers that are members of the loyalty program.

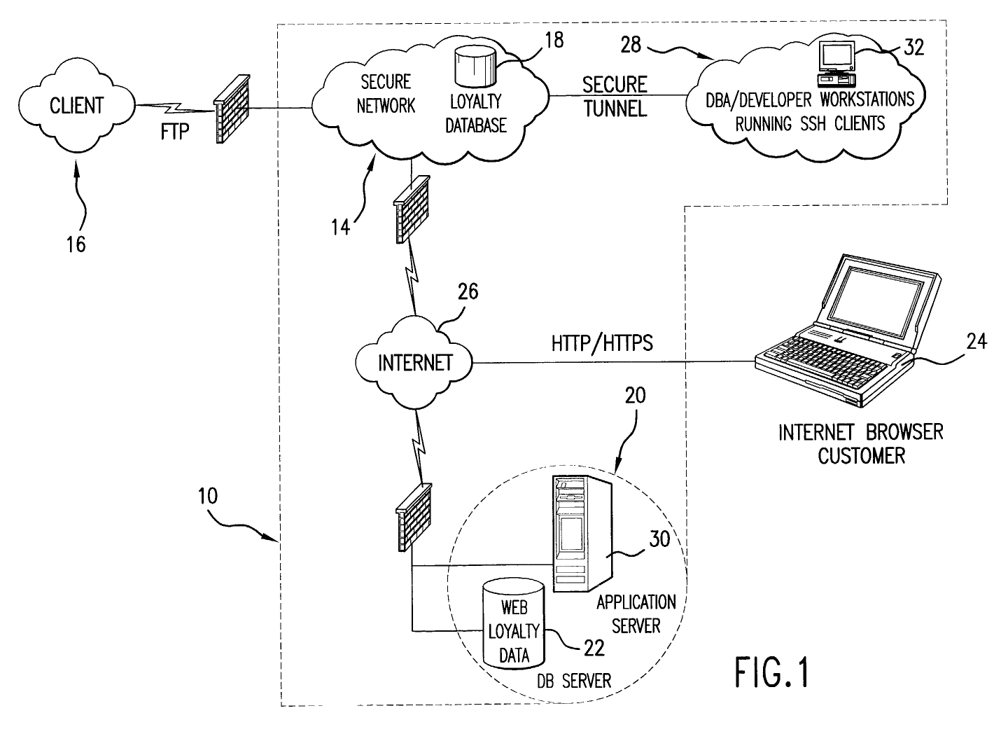

Referring now to FIG. 1, an embodiment of an interactive online point redemption system 10 according to the present invention is shown implemented over a distributed network such as the Internet. For purposes of illustration, the system 10 is shown as a plurality of computer systems located at a plurality of remote sites, where by “computer system” is meant one or more computers in standalone or networked configuration including any hardware, software and peripheral devices associated therewith to carry out assigned functions. Three computer systems at three different sites are shown. It will be appreciated, however, that the interactive online point redemption system can be implemented using any number of computer systems operating at any number of sites. For example, the system can be implemented using one or more computer systems located at a single site, a pair of computer systems located at two sites, etc.

Referring still to FIG. 1, the interactive online point redemption system 10 is shown including a first computer system 14 for interfacing with one or more third party loyalty program computer systems 16 and maintaining a primary or back end loyalty database 18, a second computer system 20 for maintaining a secondary or front end loyalty database 22 and interfacing with one or more customer computers 24 via the Internet 26, and a third computer system 28 for administering updates and transferring information between the first and second computer systems. The first computer system 14 includes a plurality of computers connected via a secure network, such as a local area network (LAN) or wide area network (WAN). A first computer (not shown) functions as a database server to maintain the primary loyalty database 18. At least one of the computers includes a file transfer protocol (FTP) port or other means configured to receive data files from remote third party loyalty program computer systems 16. The FTP port is preferably implemented on a computer having a firewall or other security features in place to prevent direct access to the primary loyalty database 18.

The data files will typically include up-to-date information about customers participating in a particular loyalty program but may also include other types of information (e.g., concerning special bonus programs or promotions, etc.). Preferably, the data files will include sufficient biographical information about new participants to permit the interactive online point redemption system to perform redemption activities without prompting the customer for additional biographical information. The data files can be automatically retrieved and loaded directly into the primary loyalty database 18 by the first computer system 14, for example at predefined intervals, or retrieval and loading of the data files can be performed on command, for example via instructions from the third computer system 28. Alternatively, information from third party loyalty programs can be stored on electronic storage media such as magnetic tapes or disks and sent to the operator of the interactive point redemption system for loading into the primary loyalty database. In yet another alternative, information from third party loyalty programs can be sent as hard copy and manually entered or scanned into the system.

It will be appreciated that customer information from a plurality of third party loyalty programs can be stored by the interactive point redemption system so that participants in different programs can simultaneously engage in redemption activities using the same redemption system. As will be described in greater detail below, the system can be configured to customize the appearance of pages displayed to a customer based upon the loyalty program in which they participate. For example, the system can generate pages including the logo of a third party in whose loyalty program the customer participates.

The second computer system 20 preferably includes a first computer (not shown) that functions as a database server and a second computer 30 that functions as a web/application server. The first computer maintains the secondary loyalty database 22, and the second computer 30 interfaces with the first computer via a secure local connection and with enrolled customers via the Internet 26. The second computer system preferably includes an FTP port or other means for receiving up-to-date third party information about enrollees from the primary loyalty database and transferring up-to-date redemption information from the secondary loyalty database to the primary loyalty database at predefined intervals. The second computer preferably also hosts the website described below.

The third computer system 28 includes one or more computers 32 connected to the first and second computer systems 14 and 20 via one or more secure links. As mentioned above, this computer system can be used to initiate data transfers between the other two computer systems, to update applications, and perform other executive and maintenance activities.

To use an interactive online point redemption system according to the present invention, a customer accesses the Internet in the usual manner utilizing a remote computer. Once connected to the Internet, the customer accesses a website hosted by the interactive point redemption system web server via a link from a third party website or by specifying in the customer's internet browser a website address corresponding to the redemption system web server domain.

In a preferred embodiment, the interactive point redemption system is configured to accept an identifier (e.g., via HTTP POST/GET actions) from a third party website when a customer comes to the interactive point redemption system website. This identifier is stored and returned with the customer when the customer opts to return to the client's site. This allows clients to maintain session information and “recognize” when a member leaves and returns to their site. If the customer comes from a client's web site, this functionality allows the system to build a homepage for the customer having the look and feel of the client's website by retrieving logos, graphics, text, fonts and/or other client-specific features from a database and incorporating such features into a generic page template containing other information about the interactive point redemption system. If the customer accesses the website directly or via the website of a third party that is not a client, a default or generic homepage without any client-specific features can be provided.

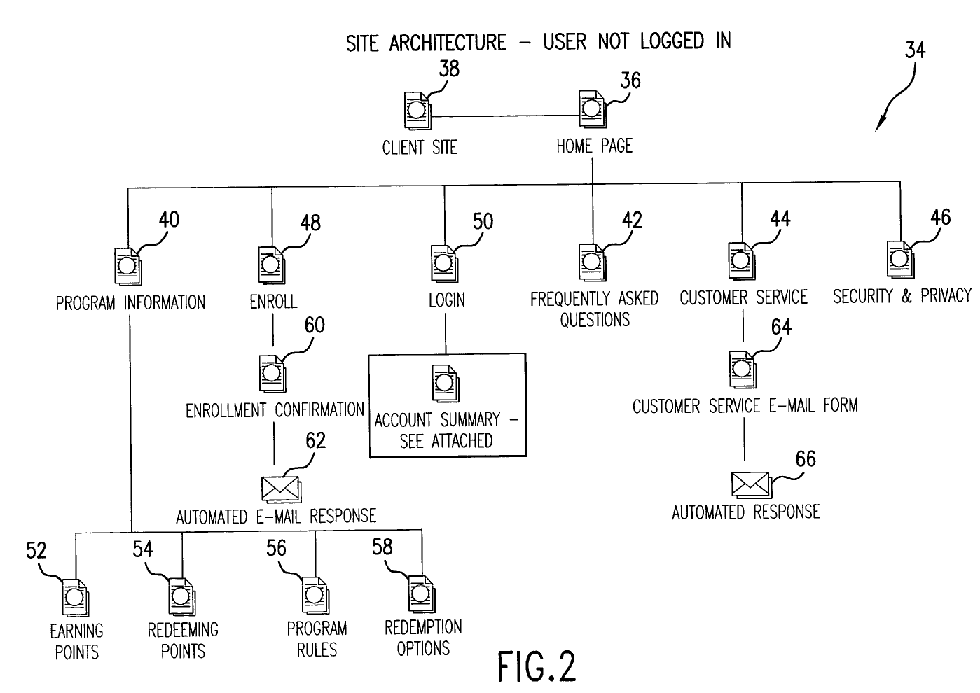

A site map showing the architecture of a website 34 hosted by an embodiment of an interactive point redemption system according to the present invention is illustrated in FIG. 2. As can be seen, the homepage 36 of the website 34 can be accessed from a third party client site 38. The homepage 36 includes links to other pages on the website such as, for example, a Program Information page 40, a Frequently Asked Questions (FAQ) page 42, a Customer Service page 44, a Security and Privacy page 46, an Enroll page 48, and a Login page 50. These pages may in turn contain links to other pages as shown. For example, the Program Information page 40 may link to pages 52, 54, 56 and 58 with information on earning points, redeeming points, program rules, and redemption options, respectively; the Enroll page 48 may link to an Enrollment Confirmation page 60 upon submission of an enrollment form and provide an automated e-mail response as shown at 62; and the Customer Service page 44 may link to an e-mail form 64 and provide an automated response as shown at 66 in response to submission of the form.

If the customer participates in a third party loyalty program but is not yet an enrolled user of the interactive point redemption system, they can access the Enroll page 48, input appropriate identifying information, and select a unique password that allows them to log onto the interactive point redemption system. Information provided by the customer on the Enroll page 48 is submitted to the system which, upon successful enrollment, will display the Enrollment Confirmation page 60 and generate the automated e-mail response.

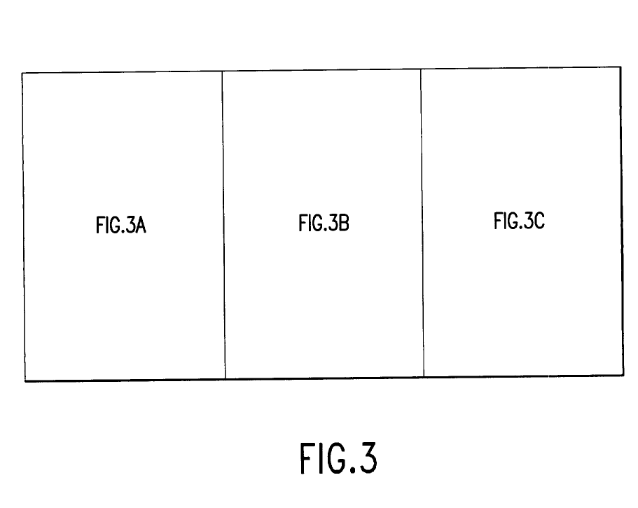

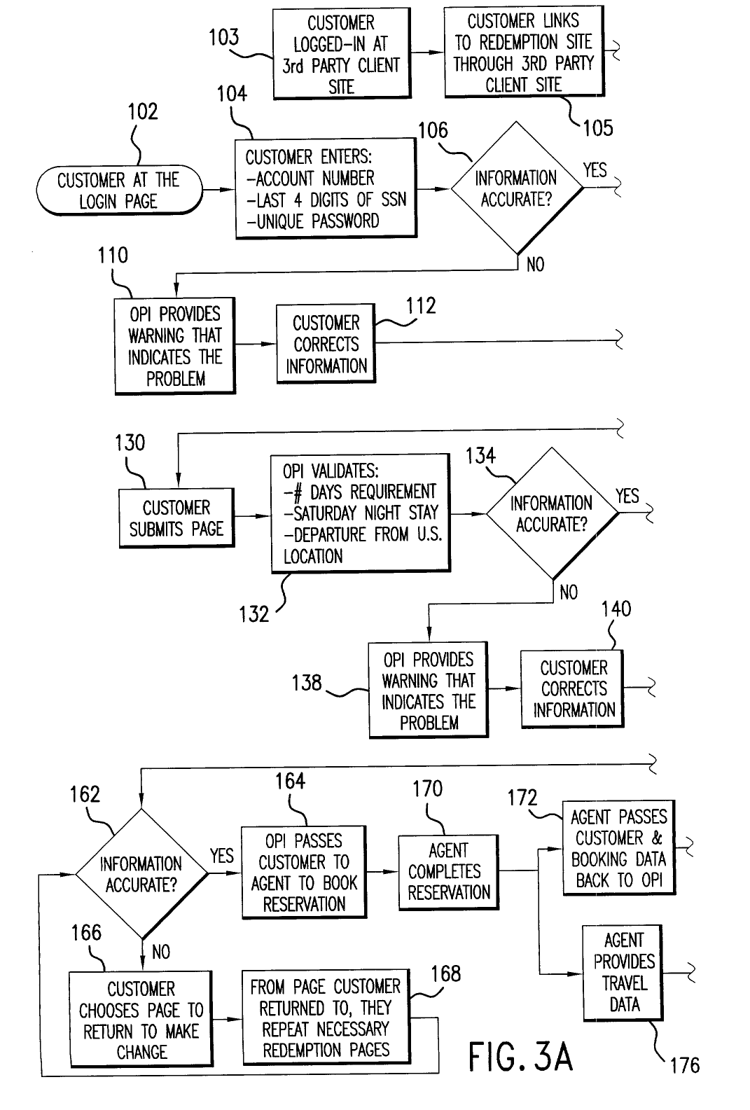

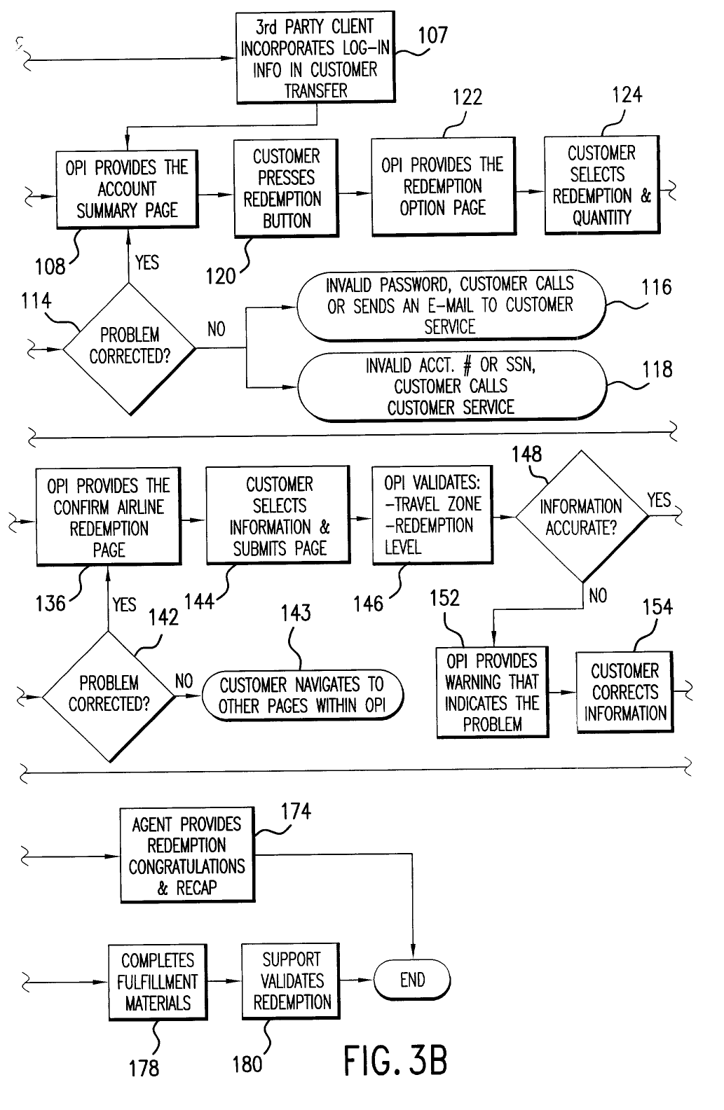

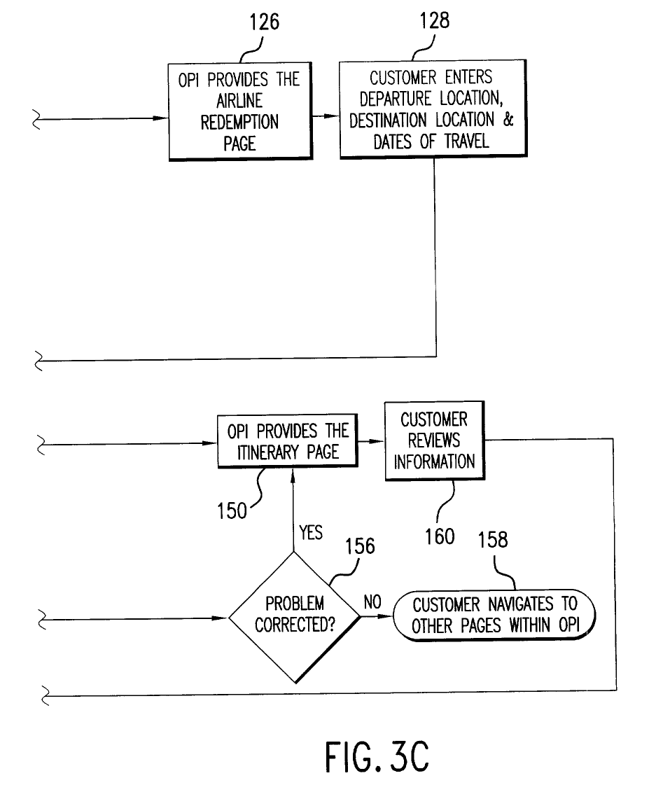

Referring now to FIG. 3, there is shown a flowchart 100 illustrating operation of the interactive point redemption system. When the customer accesses the redemption website directly, the customer must first log in or identify herself. As shown in step 102, the system will send to the customer's browser a login page with spaces for entry of login information such as an account number and a password. In a preferred embodiment, the account number is assigned to the customer by the third party loyalty program and is provided to the interactive point redemption system along with other customer information for entry into the primary and secondary loyalty databases. As mentioned above, the password is selected by the customer during enrollment into the interactive point redemption system.

The customer enters the login information at step 104 and submits the information to the system for verification. The system compares the entries submitted by the customer with information in the secondary loyalty database at step 106 to verify that the customer is an enrolled participant in an associated client loyalty program. If the information is accurate, the system provides an account summary page to the customer at step 108. If the information provided by the customer is not accurate, the system provides a warning to the customer at step 110 indicating the problem and provides an opportunity for the customer to correct the information at step 112. The system determines if the problem is corrected at step 114 and, if not, the customer is prompted to contact customer service at steps 116 or 118. If the system determines that the problem is corrected, the system then provides the account summary page to the customer as shown in step 108. The account summary page displays a summary of the customer's account including information such as, for example, the name and address of the customer, a current point balance, point earning cap, and detailed earning and redemption data including pending redemptions.

Instead of directly specifying the IP address of the redemption system website, a customer alternatively may access the redemption system website from the merchant client's website. As shown in step 103, a customer may be already logged-in at the merchant client's website, and at step 105 the customer indicates a desire to link or transfer to the redemption site, such as by clicking on a redemption site icon in a web page of the merchant client's web site. In this case, the merchant client's server automatically incorporates the customer's log-in information in transferring the customer to the redemption system website, as shown in step 107. Because the customer is already logged-in at the merchant client's website, the accuracy check and verification and correction steps are not necessary. Consequently, the process advances directly to step 108 wherein the customer will be presented with her account summary page.

The system preferably displays a button icon linking to a redemption page that is accessible from the account summary page. If the customer wishes to view the awards available for redemption, the customer can click on the button icon as indicated in step 120. The system then provides a redemption page at step 122. The redemption page preferably includes a list of awards and their point value. Some examples of the types of awards that can be redeemed include air travel, coupons, gift certificates, and merchandise.

In a preferred embodiment, the interactive point redemption system enforces a program cap set by the client. If a program cap is specified, airline travel is offered on the redemption page without price information if the ticket price is under the program cap. If the ticket price is over the cap, only the difference is revealed. (E.g., if the program cap is $500 and the ticket is $525, the user is only shown a $25 price).

The interactive point redemption system can also enforce a “hard cap” on the redemption page. A “hard cap” is the highest value ticket that may be shown. (E.g., if the program cap is $500 and the “hard cap” is $550, only tickets up to $550 will be selectable. A $525 ticket would show $25. A $575 ticket would either not be shown or not be selectable.) This encourages members to save points to go to the next higher point level, which has higher caps.

The interactive point redemption system also has the ability to cap point earnings, including the ability to create monthly “buckets” of overage amounts. If a member earns points in a month that goes over the cap amount, the overage is put into a “bucket” of points for that month. If, in the next month, the member has a reduction in points (e.g., due to returns, etc.), those points are first deducted from the overage “bucket” for that month.

If the customer desires to redeem points for one of the awards displayed on the redemption page, the customer may select an award and specify a quantity at step 124. In the case of airline travel, the system provides an airline redemption page at step 126 soliciting information such as departure location, destination location, and dates of travel. The customer enters the information at step 128 and submits the information to the system at step 130. The system validates the information at step 132, for example by ensuring that the proposed travel meets requirements such as Saturday night stay, departure from a domestic location, etc. If the proposed travel is validated at step 134, the system provides a confirm airline redemption page at step 136. If the proposed travel is not validated at step 134, the system provides a warning to the customer at step 138 indicating the problem and provides an opportunity for the customer to correct the information at step 140. The system determines if the problem is corrected at step 142 and, if not, the customer is permitted to navigate to other pages within the system as shown in step 143. If the system determines that the problem is corrected, the system then provides the confirm airline redemption page to the customer as shown in step 136.

The customer reviews the flights listed on the confirm airline redemption page; and, after selecting the flight(s) desired and submitting the selection to the system at step 144, the system validates the selection at step 146. If the system determines at step 148 that the selected flight meets criteria such as travel zone and redemption level, the system provides, at step 150, an itinerary page summarizing the flight information. If the proposed travel is not validated at step 148, the system provides a warning to the customer at step 152 indicating the problem and provides an opportunity for the customer to correct the information at step 154. The system determines if the problem is corrected at step 156 and, if not, the customer is permitted to navigate to other pages within the system at step 158. If the system determines that the problem is corrected, the system then provides the itinerary page to the customer as shown in step 150.

The customer reviews the information on the itinerary page at step 160 and, if the customer determines that the information is accurate at step 162, the system passes the customer and flight redemption data to an air travel booking website such as Fare Agent™ hosted by Cendant, Inc., at step 164. If the customer determines at step 162 that the information is not accurate, the customer may choose to return to a previous page at step 166 where they can correct the information and repeat necessary redemption pages as shown in step 168. If the customer determines that the information is now correct, the system passes the customer and flight redemption data to the air travel booking website at step 164.

Some examples of the type of data that can be sent include a redemption identification number generated by the system, customer account number, client number, customer name, number of points redeemed, price cap reflecting cost that client is willing to pay, total cap (if any) reflecting maximum value of ticket, depart date, return date, origin city, destination city, ticket class (e.g., coach, business, first), number of tickets being redeemed for points, number of companion tickets being purchased, days in advance, flag indicating whether or not Saturday night stay is required, companion ticket docket number (if any), shipping address for tickets, seat preference, a web address (URL) to use when returning data to the system, customer e-mail address, a flag indicating whether or not shipping address is a P.O. box for purposes of determining whether or not FedEx can be used, and cardholder telephone number.

The air travel booking website reserves the flights requested as described in greater detail below and, after the reservation is completed at step 170, the air travel booking website passes the customer booking data back to the interactive point redemption system at step 172, and provides redemption congratulations and a recap at 174. The air travel booking website also provides travel data to the first computer system at step 176. The first computer system completes fulfillment materials at step 178 and validates redemption at step 180.

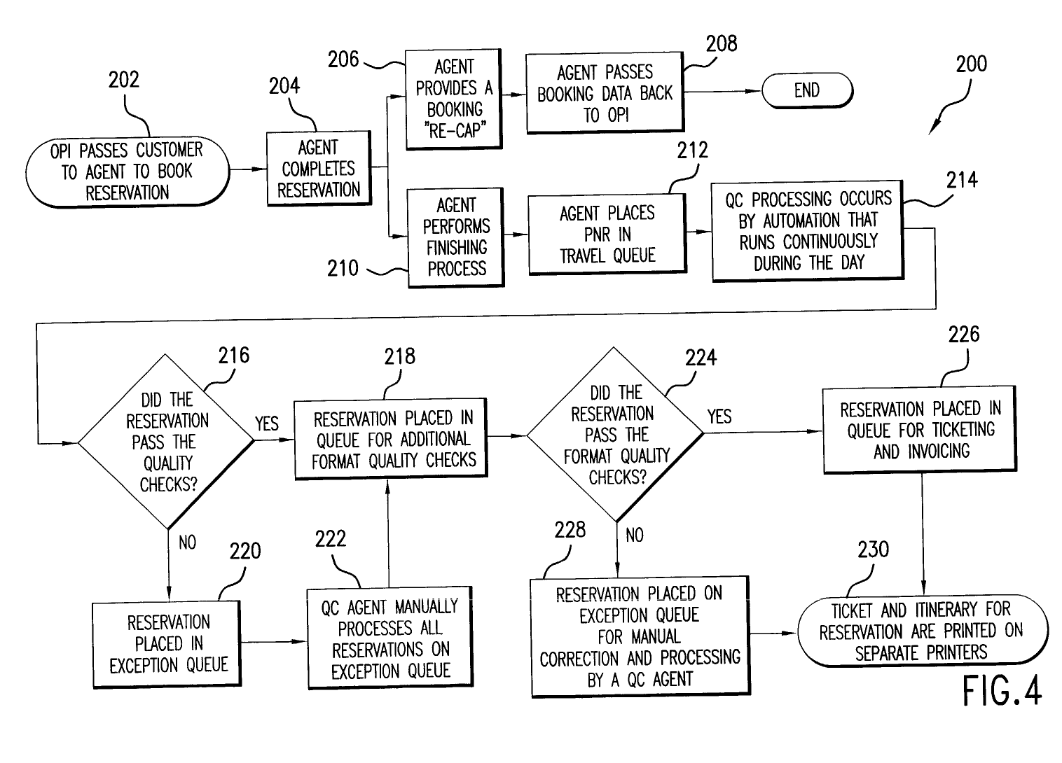

Referring to FIG. 4, there is shown a flowchart 200 illustrating an embodiment of a fare booking system or agent for use with the interactive point redemption system according to the present invention. In step 202, the interactive point redemption system passes the customer to a website hosted by the fare booking system. The fare booking system completes the reservation at step 204 using an airline reservation system, such as SABRE, provides a booking recap page to the customer at step 206, and passes the customer booking data back to the interactive point redemption system at step 208. The fare booking system also performs a finishing process at step 210, and places travel data in a queue for quality control by the third computer system at step 212. Quality control processing occurs by automation at step 214, preferably continuously throughout the day, and if the third computer system determines that the reservation passes the quality check at step 216, the reservation can be placed in an optional second queue at step 218 for additional format quality checks. If the system determines that the reservation did not pass the quality check, the reservation is placed in an exception queue at step 220 and a quality control agent manually processes the reservation at step 222, after which the reservation is placed in the optional second queue at step 218. If it is determined that the reservation passes the second quality check at step 224, the reservation is placed in a third queue for ticketing and invoicing at step 226. If it is determined that the reservation does not pass the second quality check, the reservation is placed in a second exception queue at step 228 for manual correction and processing by a quality control agent, after which the ticket and itinerary are printed at step 230 and forwarded to the customer.

One of the advantages of the foregoing system is that the airline booking is done completely online from the customer's perspective. Members can choose destination and dates, select airline options and pay any overages and mailing fees online. The airline booking engine can notify the interactive point redemption system in real-time that an airline ticket was booked allowing points to be immediately deducted from the customer's account.

A further advantage of the system is that it can allow members to book flights on a number of different airlines rather than limiting members to a specific airline.

Another advantage is that airline tickets booked online can be put into the same reservation queue (e.g., in SABRE) as offline bookings and processed from within the interactive point redemption system. As mentioned above, tickets can be printed and mailed from the interactive point redemption system, giving the system complete control of all aspects of the process.

Still another advantage is that the interactive point redemption system can enforce program rules (e.g., number of days in advance, Saturday night stay requirement and zone restrictions) through the online application. This enables the system to rely on the travel booking engine provider only for bookings. The interactive point redemption system can be configured to take on the responsibilities that are currently handled by the travel engine or change travel booking engines with minimal effort since a majority of logic is currently incorporated into the interactive point redemption system.

Yet another advantage is that the interactive point redemption system offers enrollment without the need for filling out an exhaustive form that includes address, etc., because this information is provided by the client on the back end. Customers only need to identify themselves to “activate” their account for online access.

An additional advantage is that use of the interactive point redemption system by the customer does not require any software except the ubiquitous web browser.

While the invention has been described in detail above, the invention is not intended to be limited to the specific embodiments as described. It is evident that those skilled in the art may make numerous uses and modifications of and departures from the specific embodiments described herein without departing from the inventive concepts.

For example, the customer interface can be created based on a template that allows clients to offer a client-branded loyalty web site, with the opportunity to change graphics and information whenever needed. For example, clients may specify font style (Arial, times, etc.), font size (12 point, +1, etc.), font color, background color, background images, banner images, menu images and navigation style for the interface. All verbiage, except that reserved by the interactive point redemption system for member instructions, can be customizable by the client.

E-mail addresses can be collected for clients by the interactive point redemption system. This can be a very desirable feature, as many traditional products (e.g., credit card loyalty programs) do not currently collect this type of information. The interactive point redemption system can be configured to collect and provide this information to clients on behalf of their customers who are members of their loyalty program.

The interactive point redemption system can be configured to permit the customer to submit customer service e-mail requests (e.g., from a web site on the system). Such e-mail requests can be routed to call-center staff familiar with the loyalty program and with access to customer data as well as client program information. Members can ask questions about the program, inquire about point balances, redeem points, etc., through the web interface or a phone center (including a voice recognition unit (VRU) option).

While separate airline confirmation and itinerary review processes are described, it will be appreciated that airline redemption information can be reviewed by the customer in a single process before the customer is passed to the booking agent.

In addition to allowing customers to book airline tickets for themselves, the interactive point redemption system can be configured to allow customers to book companion tickets. This feature can be implemented by the system at the redemption stage or by the booking engine. Such companion tickets can be paid for online using a credit card if desired.

The interactive point redemption system can be configured to allow clients to manage and maintain customer records (including adding new members, adding transactions, modifying member records, etc.). This self-service application can be configured to permit access through a dial-up facility that gives clients direct access to the back end (primary) database or to permit access via a web-enabled connection.

The interactive point redemption system can also be configured to allow clients to set up short-term earning and redemption opportunities for members. Clients can access the system via a dial-up connection or log into a web interface and set up programs such as 2-for-1 specials, customized surveys, etc., that will automatically provide earnings bonuses to members.

The interactive point redemption system can also be configured to offer a customizable survey component, for example via a link from the home page or after a redemption has been completed. Clients may offer point bonuses for customers opting to fill out surveys. The system can be configured to allow the client to customize the survey questions.

The interactive point redemption system can also be configured to track client promotions by collecting a promotion code when a member is sent to the interactive point redemption system site or when a member provides a predefined code at enrollment. The interactive point redemption system can then give bonus points or provide the client with a report of accounts and promotional codes for tracking and fulfillment activities. (E.g., the client can define a code that, when entered, will cause the customer to receive a phone card.)

The interactive point redemption system can provide multiple ways to enroll in the program. In a first example, the client sends a customer's information to the system and the customer comes to the interactive point redemption site to activate the account. In a second example, the customer provides all enrollment information (name, address, etc.) at the enrollment page on the interactive point redemption site and the system enrolls them into the program. In a third example, the system provides a form online that can be filled out and sent (electronically or by mail) to the client who then validates the enrollment and provides the system with data as in the first example.

As mentioned previously, the system can be configured to offer a variety of awards such as airline travel, gift certificates, coupons and merchandise. In one method of redeeming for a coupon, the customer logs in, accesses the redemption page, and chooses one of the available coupon offers (i.e., offline and/or online coupons) displayed on the redemption page. Once the point balance is verified, points are deducted and the coupon redemption process begins.

Online coupons can be handled exclusively by the system. Member information, coupon denomination, etc., can be transmitted by an automated process to system partners that issue online coupons (e.g., GiftCertificates.com and iGo.com). These partners then electronically transmit coupons to customers with no more interactions with the system except for the back-end billing process.

Offline coupon requests can be transmitted to the customer service phone center from the interactive point redemption system and processed the same way as if the customer had called into the customer service phone center. The system preferably maintains an inventory of frequently requested coupons that can be sent directly from customer service.

All the redemption activity can be managed via the system's back-end billing system. This ensures that clients receive all reports and invoices from a single system, thus avoiding the coordination of multiple vendor invoices.

The redemption matrix allows the interactive point redemption system operator to enforce program rules that are acceptable to the client. Number of days in advance, Saturday night stay requirements and limits on the number of travel zones can be set up by the client in order to minimize the cost of travel redemptions.

The interactive point redemption system can be used by clients solely as a redemption engine or, if the full functionality is implemented, the system can provide program information, customer service (e-mail and phone center) and FAQ's, etc.

The interactive point redemption system can be used by clients as a redemption portal for other loyalty applications. For programs that already offer points programs, the interactive point redemption system can accept information in real-time and process an airline or certificate redemption without managing all aspects of the program.

While specific methods of transmitting data between computer systems have been described for purposes of illustration, it will be appreciated that various types of connections can be used including, but not limited to, direct connections via cable or the like, distributed connections via a LAN or WAN, distributed connections via the Internet, and/or dial-up connections.

What is claimed is:

1. A system for implementing customer loyalty reward programs instituted by different third party merchants, comprising:
a loyalty database storing customer loyalty reward program data defining a customer loyalty reward program for each of a plurality of different third party merchants, and storing customer loyalty account information for customers enrolled in each of said third party merchants' customer loyalty reward programs; and
a server interacting with customers through a communication network connection to identify the customer, retrieve from said database an identified customer's loyalty account information, retrieve from said database the customer loyalty reward program associated with the customer's loyalty account, display the customer loyalty account information to the customer over said communication network connection, and execute redemption of rewards as selected by a customer based on the customer's loyalty account information and associated customer loyalty reward program data.

2. The system of claim 1, further comprising a communication network connection that enables said merchants to upload customer loyalty account information to said loyalty database.

3. The system of claim 2, wherein customer loyalty reward program data also is uploaded by said merchants to said loyalty database through said communication network connection.

4. The system of claim 1, wherein said communication network connection comprises an Internet communication connection.

5. The system of claim 4, wherein a customer accesses said server directly, using a browser, and is presented with a login page upon initial access to said server.

6. The system of claim 4, wherein a customer accesses said server through a web page of a merchant, wherein customer login information is passed from a merchant server to said server such that the customer does not need to separately login to said system server.

7. The system of claim 1, wherein to complete execution of reward redemption, said server transfers customer reward information to an external agent.

8. The system of claim 7, wherein a reward comprises an airline ticket, and said external agent is an airline booking agent.

9. The system of claim 8, wherein said agent completes airline reservation booking based on customer-inputted information provided to said agent by said server, and said agent passes reservation booking data back to said server upon completion of booking.

10. The system of claim 5, wherein said server contains a plurality of web pages, including a loyalty reward program information page, a loyalty reward program enrollment page, and a customer service page.

11. The system of claim 6, wherein said server contains a plurality of web pages, including a loyalty reward program information page, a loyalty reward program enrollment page, and a customer service page, and further uses said customer login information to customize said web pages to appear consistent with web page characteristics of said merchant web page.

12. A method for implementing customer loyalty reward programs instituted by different third party merchants, comprising the steps of:
storing customer loyalty reward program data defining a customer loyalty reward program for each of a plurality of different third party merchants, and storing customer loyalty account information for customers enrolled in each of said third party merchants' customer loyalty reward programs;
interacting with customers through a communication network connection to identify the customer;
retrieving an identified customer's stored loyalty account information, retrieving the stored customer loyalty reward program associated with the customer's loyalty account;
displaying the customer loyalty account information to the customer over said communication network connection; and
executing redemption of rewards as selected by a customer based on the customer's loyalty account information and associated customer loyalty reward program data.

13. The method of claim 12, further comprising the step of enabling said merchants to upload customer loyalty account information to be stored.

14. The method of claim 13, wherein customer loyalty reward program data also is uploaded by said merchants to said loyalty database through said communication network connection.

15. The method of claim 12, wherein said communication network connection comprises an Internet communication connection.

16. The method of claim 15, wherein the step of customer interaction comprises the steps of customer access using a browser, and presenting said customer with a login page upon initial access.

17. The method of claim 15, wherein the step of customer interaction comprises the steps of customer access through a web page of a merchant, and passing customer login information from a merchant server such that the customer does not need to separately login to said method.

18. The method of claim 12, further comprising the step of transferring customer reward information to an external agent to complete execution of reward redemption.

19. The method of claim 18, wherein a reward comprises an airline ticket, and said external agent is an airline booking agent.

20. The method of claim 19, wherein said agent completes airline reservation booking based on customer-inputted information provided to said agent by said server, and said agent passes reservation booking data back to a system server upon completion of booking.
